(19) United States
(12) Patent Application Publication
(10) Pub. No.: US 2007/0097528 A1
(43) Pub. Date: May 3, 2007

(54) Optical barrel, optical controller,and image taking apparatus

(75) Inventors: Tatsuhiko Hagiwara, Asaka (JP); Naoyuki Nishikawa, Minami-Ashigara (JP); Tetsuya Okumura, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/590,776

(22) Filed: Nov. 1, 2006

(30) Foreign Application Priority Data
Nov. 1, 2005 (JP) 2005-318630

(51) Int. Cl. G02B 7/02

(52) U.S. Cl. 359/819

(57) ABSTRACT

An optical barrel includes an outer wall and space members. The outer wall has a plurality of tube members which are each in tube form and are engaged one another in such a manner that one tube is inserted inside another and are relatively moved by a driving force. The space members are mounted between the plurality of tube members which open and close the spaces between the plurality of tube members by expanding and contracting in response to application and release of a voltage.

### BACKGROUND OF THE INVENTION

1. Field of the Invention

The present invention relates to an optical barrel which accommodates an optical system, an optical controller which controls light, and an image taking apparatus which shoots an image formed by light incident from a subject.

2. Description of the Related Art

Recently, in the field of image taking apparatuses such as a digital camera or a digital video camera, an apparatus smaller than an ordinary-sized one is rapidly becoming available. Such a small image taking apparatus has not only a good appearance but also a merit that the a user can bring together such a apparatus with him and shoots an image whenever he wants. In addition, recently, there appears a small CCD with pixels of high quality and a small lens corresponding to the small CCD. The small CCD makes it possible for a user of the small image taking apparatus to obtain pictures of excellent quality. In such circumstances, it is required that the small image taking apparatus has a zoom function in order to carry out a telephoto shoot and a wide-angle shoot, in addition to an autofocus function which is generally available in the image taking apparatuses of an ordinary size.

A zoom function is a function that adjusts the distances between lenses by moving them in a lens barrel. In order to realize a wide range of shooting angles from a telephoto-angle to wide-angle, it is required that the traveling distance of lenses is long enough. But, the image taking apparatus becomes bulky if an image taking apparatus has a long lens barrel in order to realize a wide range of shooting angles. Moreover, in order to avoid damage of lenses, it is required that a lens barrel collapses in an image taking apparatus after shooting. Today, an ordinary image taking apparatus has a lens barrel which has a plurality of tubes and which is constituted in such a manner that one tube is inserted inside another tube. According to this type of lens barrel, in shooting, the extended state of the lens barrel is realized by extending the plurality of tubes one by one, and after shooting, the collapsed state of the lens barrel is realized by collapsing the plurality of tubes one by one. Employing such a lens barrel having a plurality of tubes enables both a wide range of shooting angles and thin image taking apparatus body.

According to the image taking apparatus employing the lens barrel which has a plurality of tubes and which is constituted in such a manner that one tube is inserted inside another tube, it sometimes happens that an image shot by the image taking apparatus deteriorates due to unnecessary light which invades through spaces between the plurality of tubes. In the field of image taking apparatuses, there is known a technique which blocks off the light invading through the spaces between the plurality of tubes by inserting rubber O-rings into the spaces between the plurality of tubes (e.g., Japanese Patent Laid-Open No. H11-14879 and Japanese Patent Laid-Open No. H11-14880). Employing this technique enables the above small image taking apparatus both that is mounted with the adequate zoom function and can avoid the deterioration of an image shot by this image taking apparatus.

However, the technique disclosed in Japanese Patent Laid-Open No. H11-14879 and Japanese Patent Laid-Open No. H11-14880 have a problem that the amount of electric power consumption in extending and collapsing the lens barrel increases due to the unnecessary loads originated from the friction between the tubes and the O-rings, as the O-ring tightly blocks the spaces between the plurality of tubes by making use of its elastic force. In addition to that, there is another problem that the ability of the O-ring for the blocking off the light decreases due to the expansion or contraction of the rubber O-rings according to temperature. For example, the rubber O-rings tend to contract when the image taking apparatus is used under circumstances at low temperature, which causes the decrease of the ability of the O-rings for the blocking off the light.

### SUMMARY OF THE INVENTION

The present invention has been made in view of the above circumstances, and provides an optical barrel, an optical controller, and an image taking apparatus that securely block off the light incident through the spaces between the plurality of tubes and that are appropriate for smooth driving.

The present invention provides an optical barrel including:

an outer wall having a plurality of tube members which are each in tube form and are engaged one another in such a manner that one tube is inserted inside another and are relatively moved by a driving force; and

space members mounted between the plurality of tube members which open and close the spaces between the plurality of tube members by expanding and contracting in response to application and release of a voltage.

The optical barrel according to the present invention has the space members which expand and contracts in response to application and release of voltages. The space members are inserted between the plurality of tube members engaged one another in such a manner that one tube is inserted inside another. Therefore, closing the spaces between the plurality of tube members by making the space members expand makes it possible to securely avoid inconvenience originated from the invasion of light, dust, water and the like through the spaces. Additionally, while relatively moving one tube member from another, opening the spaces between the plurality of tube members by making the space members contract makes it possible to avoid the friction between the plurality of tube members and the space members. This avoidance of the friction leads to the smooth movement of the plurality of tube members.

Also, in the optical barrel according to the present invention, preferably the space members each include opaque members and block off light incident through the spaces between the plurality of tube members by expanding in response to either of application and release of a voltage.

The preferred form of the optical barrel makes it possible to block off the light incident through the spaces between the plurality of tube members.

Also, in the optical barrel according to the present invention, preferably the space members include polymer actuators.

The polymer actuator that is significantly deformed by application of a voltage is preferable as the space member according to the present invention.

Also, in the optical barrel according to the present invention, preferably the space members are rings whose cross sections are circular.

Employing the rings whose cross sections are circular enables efficient blocking of the spaces between the plurality of tube members and thus decreases in the friction between the plurality of tube members and the rings, thereby saving the amount of electric power consumption when moving one tube member relatively from another.

Also, in the optical barrel according to the present invention, preferably the space members are rings whose cross sections are in polygonal form, corners of which contact and separate from the tube members, by expanding and contracting in response to application and release of a voltage.

As the rings have polygonal-form cross sections and corners configured to be detachably connected to the plurality of tube members, friction between the plurality of tube members and the rings can be suppressed, thereby saving the amount of electric power consumption when moving one tube member relatively from another.

Also, the present invention provides an optical controller including:

(a) an optical barrel having;
(i) an outer wall having a plurality of tube members which are each in tube form and are engaged one another in such a manner that one tube is inserted inside another and are relatively moved by a driving force: and
(ii) space members mounted between the plurality of tube members which open and close the spaces between the plurality of tube members by expanding and contracting in response to application and release of a voltage,

(b) an optical system which is accommodated in the optical barrel, which subject light passes through and whose optical ability is changed according to the relative movement of the plurality of tube members of the optical barrel; and

(c) a control section which controls closing and opening of the spaces by controlling application and release of a voltage with respect to the space member.

The optical controller with the above-described feature makes it possible to securely avoid inconvenience originated from the invasion of light, dust, water and the like through the spaces between the plurality of tube members.

Incidentally, only a basic form of the optical controller according to the present invention is described here, but the optical controller according to the present invention includes various forms corresponding to the various forms of the optical barrel described earlier, in addition to the basic form described above.

Also, the present invention provides an image taking apparatus including:

(a) an optical barrel having;
(i) an outer wall having a plurality of tube members which are each in tube form and are engaged one another in such a manner that one tube is inserted inside another and are relatively moved by a driving force: and
(ii) space members mounted between the plurality of tube members which open and close the spaces between the plurality of tube members by expanding and contracting in response to application and release of a voltage,

(b) an optical system which is accommodated in the optical barrel, which subject light passes through and whose optical ability is changed according to the relative movement of the plurality of tube members of the optical barrel;

(c) a control section which controls closing and opening of the spaces by controlling application and release of a voltage with respect to the space member; and

(d) an imaging section which shoots an image formed by the subject light.

The above-described image taking apparatus according to the invention enables obtaining of a high-quality image by securely blocking off the light incident through the spaces between the plurality of tube members.

Also, the image taking apparatus according to the present invention, preferably further includes a tube member driving section which gives the plurality of tube members a driving force, thereby moving the plurality of tube members relatively, wherein the control section causes the respective space members to close or open the spaces, depending upon whether the tube members are being moved by the tube member driving section.

The preferred form of the image taking apparatus makes it possible to securely avoid inconvenience originated from the invasion of light, dust, water and the like through the spaces between the plurality of tube members, in addition to making it possible to move one tube member relatively from another with less electric power consumption.

Also, the image taking apparatus according to the present invention, preferably includes:

an acceleration detection section which detects acceleration of movement of the image taking apparatus; and

a tube member driving section which gives the plurality of tube members a driving force thereby moving the plurality of tube members relatively and stops the movement of the plurality of tube members in the case that acceleration detected by the acceleration detection section is over a predetermined acceleration,

wherein the control section causes the space members to close the spaces in the case that acceleration detected by the acceleration detection section is over the predetermined acceleration.

The preferred form of the image taking apparatus makes it possible to decrease damage of the optical system by making the space members close the spaces so that the strength of the optical barrel increases when the image taking apparatus falls and so on.

Incidentally, only a basic form of the image taking apparatus according to the present invention is described here, but the image taking apparatus according to the present invention includes various forms corresponding to the various forms of the optical barrel described earlier, in addition to the basic form described above.

As described above, the present invention provides an optical barrel, an optical controller, and an image taking apparatus that securely avoid inconvenience originated from the invasion of light, dust, water and the like through the spaces between the plurality of tubes.

### BRIEF DESCRIPTION OF THE DRAWINGS

The invention will be described with reference to the accompanying figures of which:

FIG. 1 is an external perspective view of a digital camera to which the first to ninth embodiments of the present invention apply;

FIG. 2 is an external perspective view of a digital camera to which the first to ninth embodiments of the present invention apply;

FIG. 3 is a sectional view of a collapsed lens barrel of the digital camera taken along an optical axis;

FIG. 4 is a sectional view of the lens barrel of the digital camera taken along the optical axis with the image taking lens located at a Wide end;

FIG. 5 is a sectional view of the lens barrel of the digital camera taken along the optical axis with the image taking lens located at a Tele end;

FIG. 6 is a schematic diagram showing an internal configuration of the digital camera shown in FIG. 1;

FIG. 7A shows a sectional view of the space member.

FIG. 7B shows a sectional view of the space member.

FIG. 8 is a flowchart showing the procedure of the control of contracting and expanding of the space member.

FIG. 9A shows relationship between the space member and the lens barrel.

FIG. 9B shows relationship between the space member and the lens barrel.

FIG. 10A shows a sectional view of the space member which is employed in the second embodiment.

FIG. 10B shows a sectional view of the space member which is employed in the second embodiment.

FIG. 11A shows relationship between the space member and the lens barrel.

FIG. 11B shows relationship between the space member and the lens barrel.

### DETAILED DESCRIPTION OF THE INVENTION

Embodiments the present invention will be described below with reference to the drawings.

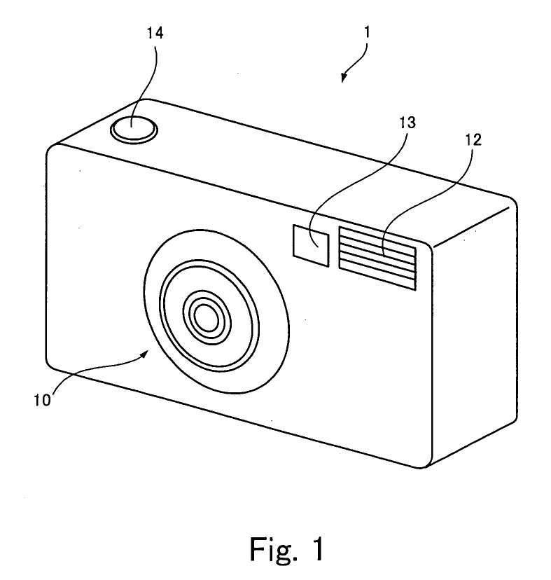

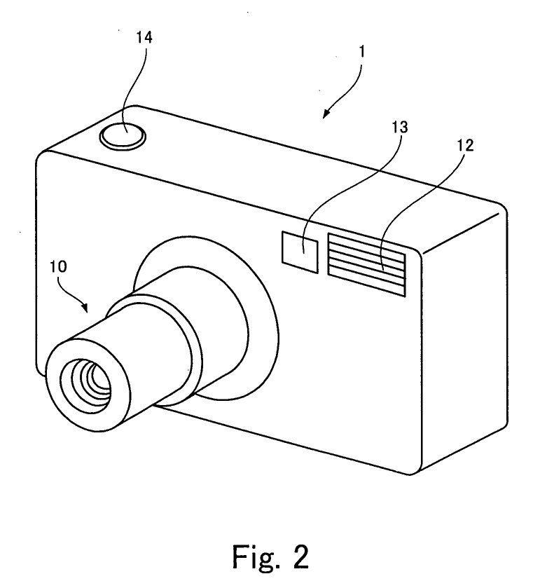

FIGS. 1 and 2 are external perspective views of the digital camera to which an embodiment of the present invention applies.

FIG. 1 shows a lens barrel 10 of the digital camera 1 in its collapsed state, where the lens barrel 10 incorporates an image taking lens. FIG. 2 shows the lens barrel 10 in its extended state.

On the upper front part of the digital camera 1 shown in FIGS. 1 and 2, there are a fill flash window 12 and a finder objective window 13. On the top face of the digital camera 1, there is a shutter button 14.

Various switches such as a zoom control switch and a cross-key pad as well as an LCD (liquid crystal display) for use to display images and a menu screen are mounted on the back (not shown) of the digital camera. If the zoom control switch is held down for a predetermined time or longer, the digital camera 1 enters a zoom control mode in order to adjust the angle of view. While an Up key of the cross-key pad is held down, an image taking lens (described later) moves to a telephoto side (Tele side). While a Down key of the cross-key pad is held down, the image taking lens moves to a wide-angle side (Wide side).

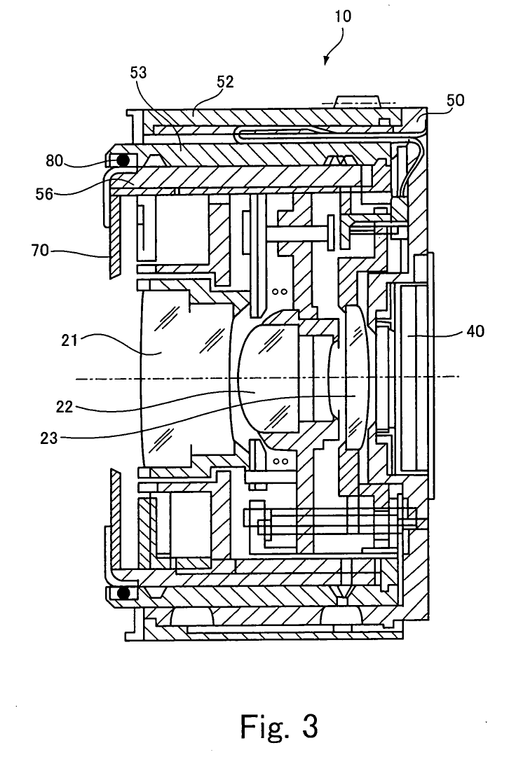

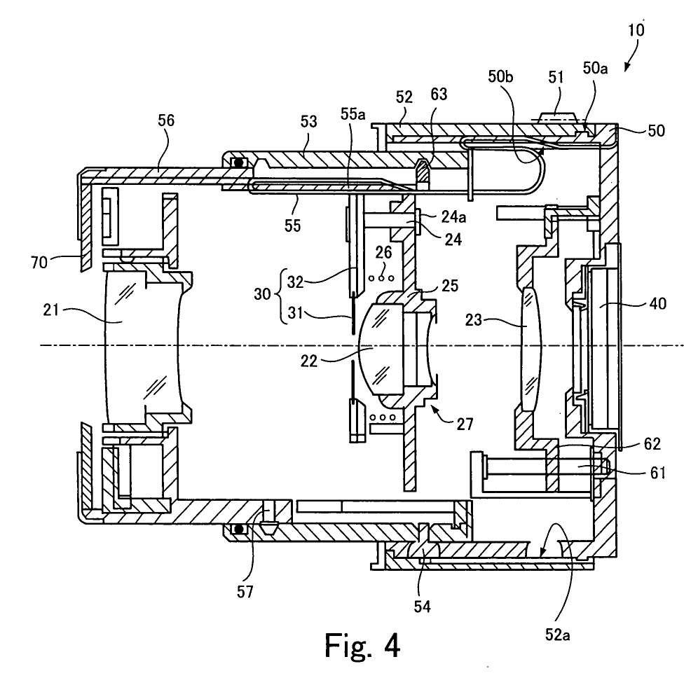

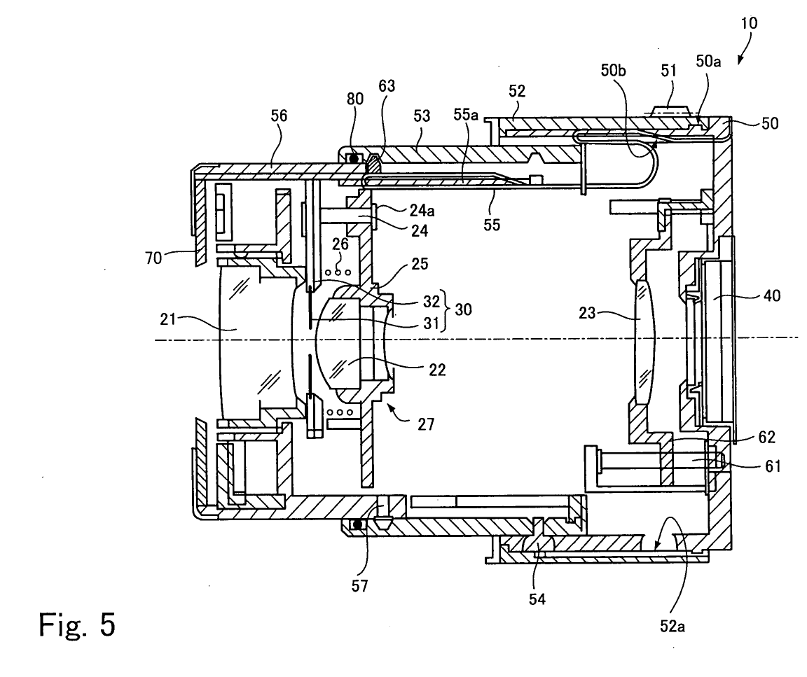

FIG. 3 is a sectional view of the collapsed lens barrel 10 of the digital camera 1 taken along the optical axis, FIG. 4 is a sectional view of the lens barrel 10 of the digital camera 1 taken along the optical axis with the image taking lens located at the Wide end, and FIG. 5 is a sectional view of the lens barrel 10 of the digital camera 1 taken along the optical axis with the image taking lens located at the Tele end.

The lens barrel 10 contains in its interior space the image taking lens which includes a front-group lens (first lens group) 21, a rear-group lens (second lens group) 22, and a focus lens (third lens group) 23 arranged from the front to the rear and in this order and aligned with their optical axes. The image taking lens is configured such that the rear-group lens 22 moves along the optical axis between the Wide end shown in FIG. 4 and the Tele end shown in FIG. 5 for focal length adjustment by changing the angle of view and that the focus lens 23 moves along the optical axis for focus adjustment. The front-group lens (first lens group) 21, rear-group lens (second lens group) 22, and focus lens (third lens group) 23 are examples of the optical system according to the present invention and the lens barrel 10 is an example of the optical barrel according to the present invention.

A flare prevention plate 70 is placed further ahead of the front-group lens 21 to shut out harmful light, an iris unit 30 is placed between the front-group lens 21 and rear-group lens 22 to adjust light quantity of light incident from a subject, and a CCD 40 is placed behind the image taking lens to read the light incident from a subject. The CCD 40 is an example of the imaging section according to the present invention.

As shown in FIGS. 4 and 5, the iris unit 30 has an aperture plate 32 in which a hole is made around the optical axis of the image taking lens and iris blades 31 which adjust the amount of opening by throttling the hole in the aperture plate 32. Also, the iris unit 30 has a guide rod 24 which protrudes backward from the back of the iris unit 30 and a stopper 24a which is attached to the rear end of the guide rod 24. The guide rod 24 penetrates a rear-group lens holder frame 25 that holds the rear-group lens 22 in such a way that the rear-group lens holder frame 25 can slide along the optical axis. Furthermore, a coil spring 26 is mounted in compression between the iris unit 30 and rear-group lens holder frame 25. The iris unit 30 is held in so as to be slidable along the optical axis, being spring-biased forward against a rear-group lens unit 27 composed of the rear-group lens 22 and the rear-group lens holder frame 25. When the lens barrel 10 is collapsed, the iris blades 31 shown in FIGS. 4 and 5 are opened and the iris unit 30 moves toward the rear-group lens unit 27, compressing the coil spring 26 and thereby pushing the rear-group lens unit 27 into the hole in the aperture plate 32. This makes it possible to reduce the thickness of the digital camera 1.

Also, the lens barrel 10 has a fixed tube 50 fixed to the camera body, a driving tube 52 rotatable around the fixed tube 50, a rotational tube 53 which rotates along with rotation of the driving tube 52, and a translatory tube 56 which moves straight along with rotation of the rotational tube 53. In the collapsed state of the lens barrel 10, as shown in FIG. 3, the fixed tube 50, the driving tube 52, the rotational tube 53 and the translatory tube 56 are accommodated in such a manner that one tube is inserted inside another tube. In the extended state of the lens barrel 10, as shown in FIG. 4 and FIG. 5, the driving tube 52 surrounds the fixed tube 50, and the fixed tube 50, the rotational tube 53 and the translatory tube 56 are extended in such a manner that one of the tubes partially overlaps another tube. The rotational tube 53 and the translatory tube 56 are examples of the plurality of tubes according to the present invention, and a wall surface of the lens barrel 10 formed by the rotational tube 53 and the translatory tube 56 is an example of the outer surface according to the present invention.

Also, between the portions of the rotational tube 53 and the translatory tube 56 which are overlapping each other, there is a ring-shaped space member 80 in order to block a space between the rotational tube 53 and the translatory tube 56. The space member 80 is made of a polymer actuator (described later) which expands and contracts in response to application and release of a voltage. When the lens barrel 10 is being extended or collapsed, the space member 80 contracts to open a space between the rotational tube 53 and the translatory tube 56. This makes it possible to avoid the friction between the space members and the rotational tube 53, and between the space members and the translatory tube 56. When the lens barrel 10 stops its movement, the space member 80 expands to block the space between the rotational tube 53 and the translatory tube 56. This makes it possible to avoid inconvenience originated from the invasion of light, dust, water and the like through the space. The space member 80 is an example of the space member according to the present invention.

In the following, the driving of the lens barrel 10 and the image taking lens is described.

Movement of the driving tube 52 along the optical axis with respect to the fixed tube 50 is restricted by engageable insertion of a ridge 50a formed circumferentially on an outer surface of the fixed tube 50 into a groove formed in an inner surface of the driving tube 52. The driving tube 52 is rotated by a rotational driving force transmitted from a motor (not shown) via a gear 51 on an outer surface of the driving tube 52.

Furthermore, the driving tube 52 has a keyway 52a which extends along the optical axis, and a pin-like cam follower 54 mounted on a rotational tube 53 is engageably inserted in the keyway 52a through a spiral cam groove cut in the fixed tube 50. Consequently, when the driving tube 52 rotates, the rotational tube 53 moves in the direction of the optical axis, rotating along the cam groove.

A translatory frame 55 is installed inside the rotational tube 53. The translatory frame 55 is engaged with the rotational tube 53 so as to be rotatable relative to the rotational tube 53, but has its movement restricted by being engageably inserted into a keyway 50b of the fixed tube 50. Consequently, when the rotational tube 53 moves in the direction of the optical axis, rotating along with rotation of the driving tube 52, the translatory frame 55 moves linearly in the direction of the optical axis along with the rotation of the rotational tube 53.

A pin-like cam follower 63 is secured to the rear-group lens holder frame 25 which holds the rear-group lens 22. The pin-like cam follower 63 is engageably inserted in the cam groove of the rotational tube 53 as well as in a keyway 55a of the translatory frame 55. Consequently, when the rotational tube 53 moves in the direction of the optical axis, rotating along with rotation of the driving tube 52, the rear-group lens unit 27 moves straight in the direction of the optical axis, following the shape of the cam groove in the rotational tube 53.

Since the iris unit 30 is mounted on the lens unit 27, being biased forward by the coil spring 26 as described above, the iris unit 30 moves in the direction of the optical axis together with the lens unit 27.

The translatory tube 56 in the lens barrel 10 holds the front-group lens 21. A cam follower 57 secured to the translatory tube 56 is engageably inserted in the cam groove of the rotational tube 53 as well as in the keyway 55a of the translatory frame 55, with the keyway 55a extending along the optical axis. Consequently, when the rotational tube 53 moves in the direction of the optical axis, rotating along with rotation of the driving tube 52, the translatory tube 56 moves straight in the direction of the optical axis, following the shape of the cam groove in the rotational tube 53 in which the cam follower 57 is engageably inserted.

The lens barrel 10 is extended in this way, and it is collapsed when the driving tube 52 rotates in the opposite direction. A combination of the gear 51 and the motor connected with the gear 51 and the like is an example of the tube member driving section.

Even after the lens barrel 10 completes its extension, the rotational tube 53 can further rotate while maintaining the position of the front-group lens 21. At this time, the rear-group lens unit 27 moves in the direction of the optical axis along the cam groove of the rotational tube 53, adjusting the angle of view (and thus, the focal length). FIG. 4 shows the lens barrel 10 at the completion of its extension. At this time, the image taking lens is located at the Wide end. FIG. 5 shows the state which takes place as the rotational tube 53 rotates further after the completion of the extension, moving the rear-group lens unit 27 until the image taking lens is located at the Tele end.

The focus lens 23 in the image taking lens is moved along the optical axis along with rotation of a lead-screw 61 driven by the motor (not shown) because the lead-screw 61 is screwed into a focus lens holding flame which holds the focus lens 23, thereby adjusting focus.

Next, an internal configuration of the digital camera 1 will be described.

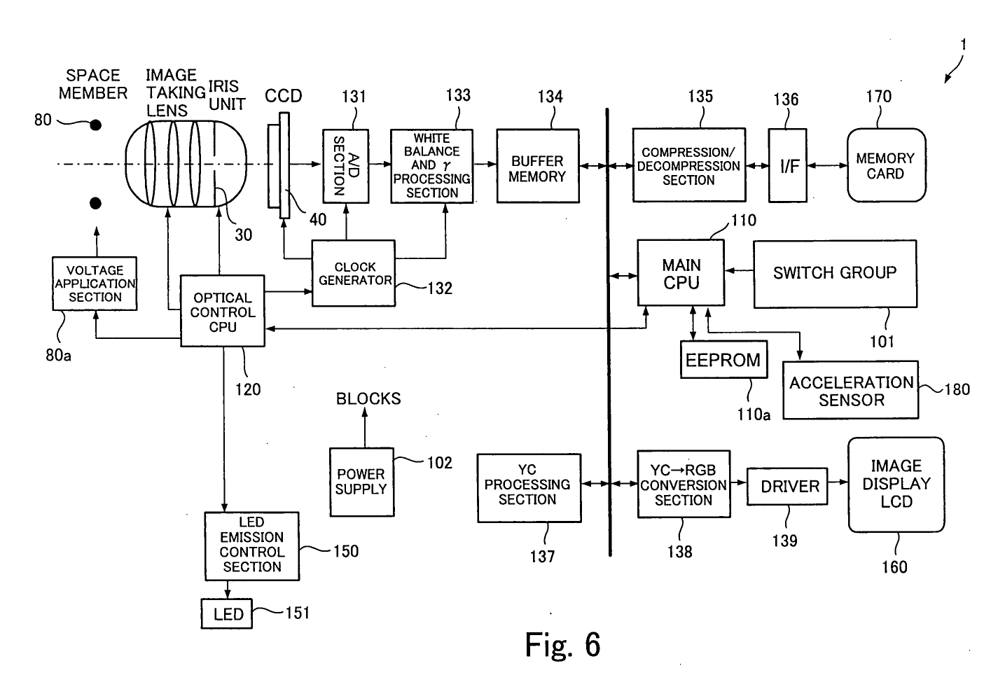

FIG. 6 is a schematic diagram showing an internal configuration of the digital camera 1 shown in Fig.

The digital camera 1 has all its processes controlled by a main CPU 110. The main CPU 110 is supplied with operation signals from various switches (which include the shutter button 14 shown in FIG. 1, zoom control switch, and cross-key pad and will be referred to hereinafter collectively as a switch group 101) of the digital camera 1, and detection results by an acceleration sensor 180 which detects movement acceleration (relative acceleration) of the digital camera 1. The main CPU 110 judges whether the digital camera 1 is falling or not, based on detection results of the acceleration sensor 180. When the main CPU 110 judges that the digital camera 1 is falling, it is possible to avoid damage of the lens barrel 10 by causing the space member 80 to close the space between the rotational tube 53 and the translatory tube 56, so that the strength of the digital camera 1 increases. The acceleration sensor 180 is an example of the acceleration detection section of the present invention.

The main CPU 110 has an EEPROM 110a which contains various programs needed to run various processes on the digital camera 1. When a power switch (not shown) in the switch group 101 is turned on, power is supplied to various components of the digital camera 1 from a power supply 102 and the main CPU 110 totally controls the entire operation of the digital camera 1 according to program procedures contained in the EEPROM 110a.

First, the flow of an image signal will be described with reference to FIG. 6.

When the power switch (not shown) is turned on, the lens barrel 10 is collapsed and the space member 80 closes the space between the rotational tube 53 and the translatory tube 56 by expanding.

When a user specifies an angle of view using the cross-key pad (not shown) on the back of the digital camera 1, the specified angle of view is transmitted from the switch group 101 to the main CPU 110. The main CPU 110 calculates the focal length corresponding to the specified angle of view and the calculated focal length is transmitted to an optical control CPU 120. Meanwhile, data are exchanged between the main CPU 110 and optical control CPU 120 at high speed via inter-CPU communications rather than via a bus 140.

When the data of the focal length is transmitted from the main CPU 110, the optical control CPU 120 gives a voltage application section 80a an instruction to apply a necessary voltage of a predetermined value in order to make the space member 80 contract. In the embodiment, the polymer actuator which makes up of the space member 80 has a property that it contracts when a voltage is applied and that it expands when application of the voltage is stopped. The application of the instructed voltage to the space member 80 makes the space member 80 contract. This leads to forming of the space between the rotational tube 53 and the translatory tube 56 shown in FIG. 3, FIG. 4 and FIG. 5. A combination of the main CPU 110 and optical control CPU 120 corresponds to an example of the control section according to the present invention.

When the space member 80 contracts, by controlling a motor (not shown) and the like, the optical control CPU 120 extends the lens barrel 10 as shown in FIG. 4 and 5 and moves the rear-group lens 22 to a position corresponding to the angle of view specified by the user. Also, by controlling a motor (not shown) and the like, the optical control CPU 120 moves the focus lens 23 shown in FIG. 3, FIG. 4 and FIG. 5 in the direction along the optical axis.

When the lens barrel 10 is extended, the optical control CPU 120 gives the voltage application section 80a an instruction to stop application of a voltage. When the voltage application section 80a stops applying the voltage, the space member 80 expands, which leads to closing of the space between the rotational tube 53 and the translatory tube 56 shown in FIG. 3, FIG. 4 and FIG. 5. As a result, the light incident through the space is blocked off by the space member 80.

Light incident from a subject passes through the image taking lens and the iris unit 30 and forms an image on the CCD 40, which then generates an image signal representing a subject image. The generated image signal is roughly read by an A/D section 131, which then converts an analog signal into a digital signal to generate low-resolution live view data. The generated live view data are subjected to image processing such as white balance correction and y correction by a white balance and γ processing section 133.

The CCD 40 generates the image signal at predetermined intervals in sync with a timing signal supplied from a clock generator 132. The clock generator 132 outputs the timing signal based on instructions transmitted from the main CPU 110 via the optical control CPU 120. In addition to the CCD 40, the timing signal is also supplied to the A/D section 131 and the white balance and γ processing section 133 in subsequent stages. Thus, the CCD 40, the A/D section 131, and white balance and γ processing section 133 process the image signal in an orderly manner in sync with the timing signal generated by the clock generator 132.

After the image processing by the white balance and y processing section 133, the image data are temporarily stored in a buffer memory 134. The low-resolution live view data stored in the buffer memory 134 are supplied to a YC/RGB conversion section 138 via the bus 140 in the order in which they are stored. The live view data are provided as RGB signals, and thus they are not processed by the YC/RGB conversion section 138. Instead, they are transmitted directly to an image display LCD 160 via a driver 139, and live view from the live view data is displayed on the image display LCD 160. The CCD 40 reads light incident from a subject and generates an image signal at predetermined intervals, and thus the light incident from a subject coming from the direction in which the image taking lens is directed is displayed constantly on the image display LCD 160.

The live view data stored in the buffer memory 134 are also supplied to the main CPU 110. Based on the live view data, the main CPU 110 detects the contrast of the light incident from a subject and luminance of the subject in the image signals obtained repeatedly by the CCD 40 while the focus lens 23 is moved along the optical axis. The detected contrast and luminance are transmitted to the optical control CPU 120.

The optical control CPU 120 moves the focus lens 23 to a position where the contrast transmitted from the main CPU 110 reaches a peak (AF process) and adjusts an aperture value of the iris according to the luminance transmitted from the main CPU 110 (AE process).

When the user presses the shutter button 14 shown in FIG. 1 by checking the live view displayed on the image display LCD 160, the press of the shutter button 14 is transmitted to the main CPU 110 and further to the optical control CPU 120. If the subject is dark, the optical control CPU 120 gives an instruction for a flash to a LED emission control section 150 and a LED 151 flashes in sync with the press of the shutter button 14. Also, based on instructions from the optical control CPU 120, the image signals generated by the CCD 40 are read out finely by the A/D section 131 to generate high-resolution photographic image data. The generated photographic image data is subjected to image processing by the white balance and γ processing section 133 and stored in the buffer memory 134.

The photographic image data stored in the buffer memory 134 is supplied to a YC processing section 137, where they are converted from an RGB signal to a YC signal. After the conversion into the YC signal, the photographic image data is subjected to a compression process by a compression/decompression section 135. The compressed photographic image data is stored in a memory card 170 via an interface 136.

The photographic image data stored in the memory card 170 is subjected to a decompression process by the compression/decompression section 135, converted into an RGB signal by the YC/RGB conversion section 138, and transmitted to the image display LCD 160 via the driver 139. The image display LCD 160 displays a photographic image represented by the photographic image data.

The digital camera 1 is configured as described above.

According to the digital camera 1 of the embodiment, the space between the rotational tube 53 and the translatory tube 56 shown in FIG. 3, FIG. 4 and FIG. 5 is opened and closed by the application and release of a voltage to the space member 80. First, the constitution of the space member and the method of opening and closing thereof by the space member 80 is described below.

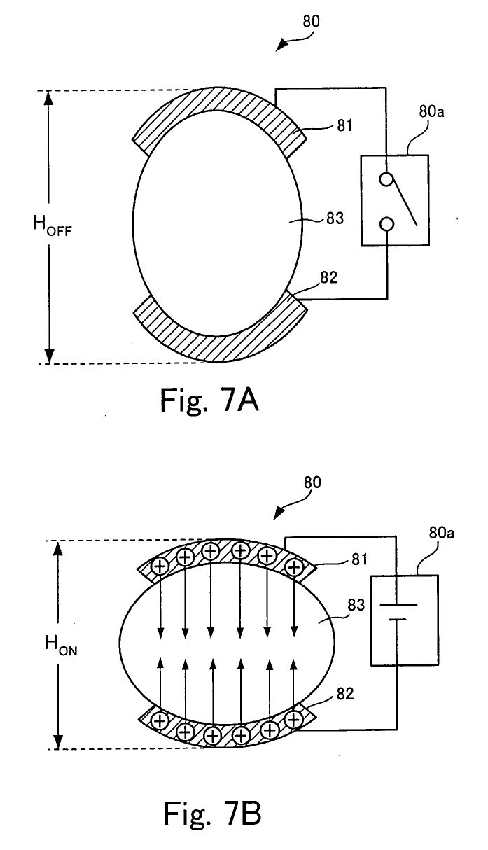

FIG. 7A and FIG. 7B each show a sectional view of the space member 80.

The space member 80 is made of an O-ring 83 whose cross section is elliptical and two electrodes 81, 82 which sandwich the O-ring 83. According to the embodiment, the O-ring 83 is made of an opaque polymer material and, the electrodes 81, 82 are made of an elastic material mixed with an opaque metallic material. The polymer material to be applied in the present invention is described later.

When the voltage application section 80a also shown in FIG. 6 does not apply a voltage to the space member 80, the electrodes 81, 82 are not attracted each other.

When a voltage is applied to the space member 80 by the voltage application section 80a, for example, in such a manner that polarity of the upper electrode 81 is plus and polarity of the lower electrode 82 in the figure is minus, plus charge is given to the upper electrode 81 and minus charge is given to the lower electrode 82, as shown in FIG. 7B. At this time, due to the attractive electrostatic force between the upper electrode 81 with plus charge and the lower electrode 82 with minus charge, the O-ring 83 is pushed from the both side. As a result, the O-ring 83 contracts between the electrode 81, 82, and the thickness Hon of the cross section of the space member 80 in FIG. 7B is thinner than the thickness Hoff of the cross section of the space member 80 in FIG. 7A.

When the voltage application section 80a stops applying a voltage to the space member 80, the electrostatic force between the electrode 81, 82 vanishes and the space member 80 expands as shown in FIG. 7A. As a result, the thickness Hon of the cross section of the space member 80 in FIG. 7B regains the original thickness Hoff shown in FIG. 7A.

The space member 80 contracts and expands as described above.

Next, control of contracting and expanding of the space member 80 will be described below.

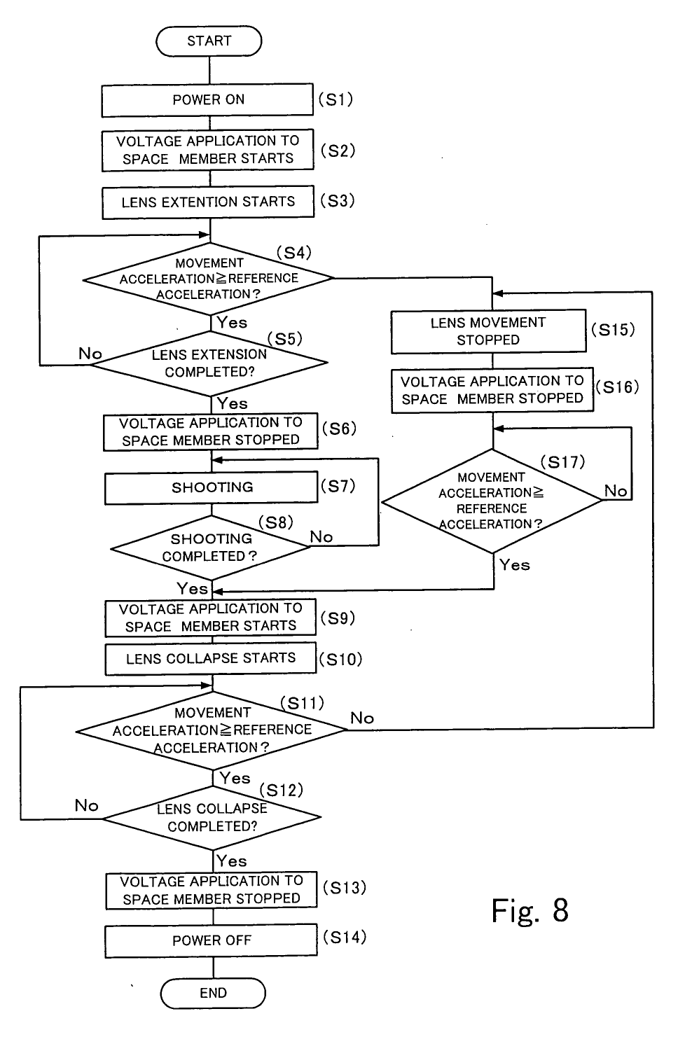

FIG. 8 is a flowchart showing the procedure of the control of contracting and expanding of the space member 80.

When the power is not supplied, the space member 80 blocks the space between the rotational tube 53 and the translatory tube 56 in FIG. 3, FIG. 4 and FIG. 5 by expanding as shown in FIG. 7A. By blocking the space in the lens barrel 10 with the space member 80 in this way when the digital camera 1 is not used, it is possible to prevent the invasion of light, dust, water and the like into the lens barrel 10. When the lens barrel 10 is in its collapsed state, it exerts higher strength against drop impact and the like. Therefore, the space in the lens barrel 10 may remain opened in the range between 0.03 mm and 0.10 mm in which dust and the like can not invade, instead of being completely blocked with the space member 80.

When the power switch (not shown) is turned on by a user, the information that the power switch is turned on is transmitted from the switch group 101 to the main CPU 110 and the power is supplied to the digital camera 1 (step S1 in FIG. 8).

Also, when a user specifies an angle of view, the specified angle of view is transmitted from the switch group 101 to the main CPU 110 and the focal length corresponding to the specified angle of view is transmitted to the optical control CPU 120.

When the data of the focal length is transmitted from the main CPU 110, the optical control CPU 120 gives the voltage application section 80a an instruction to apply a voltage.

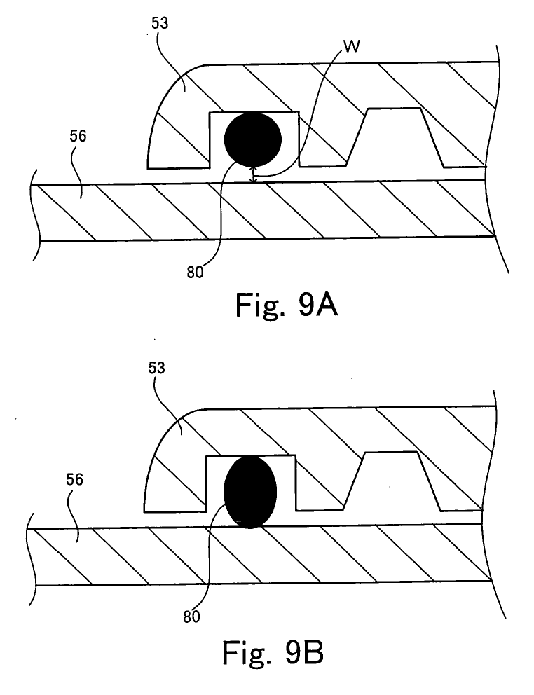

FIG. 9 shows the relationship between the space member 80 and the lens barrel 10.

As shown in FIG. 9A, the space member 80 is glued on the rotational tube 53. When the voltage application section 80a applies a voltage to the space member 80 (step S2 in FIG. 8), as shown in FIG. 7B, due to the attractive electrostatic force between the upper electrode 81 with plus charge and the lower electrode 82 with minus charge, the space member 80 contracts between the electrode 81, 82. As a result, as shown in FIG. 9A, the space W between the rotational tube 53 and the translatory tube 56 of the lens barrel 10 is opened.

When the space W is opened by the space member 80, the optical control CPU 120 causes the motor (not shown) and the like to drive the lens barrel 10 so as to be extended, as shown in FIG. 4 and FIG. 5 (step S3 in FIG. 8). Due to the space W made by contraction of the space member 80 before the lens barrel 10 is moved, it is possible to reduce the friction between the space member 80 and the lens barrel 10. This leads to the smooth movement of the lens barrel 10. Incidentally, employing the space member 80 whose cross section are circular enables reduction in the friction between the space member 80 and the lens barrel 10, even if the rotational tube 53 is stressed with full force, and thus the lens barrel 10 is moved in the state that the space member 80 is in contact with the translatory tube 56. As a result, it is possible to drive the lens barrel 10 with less electric power.

When the lens barrel 10 starts to be moved, the acceleration sensor 180 in FIG. 6 detects movement acceleration (relative acceleration) of the digital camera 1 and the detection result is transmitted to the main CPU 110.

The main CPU 110 judges whether the digital camera 1 falls or not, based on the detection result. When the digital camera 1 is static, movement acceleration of the digital camera 1 is the same as acceleration of gravity. At the moment when the digital camera 1 is away from the hands of the user, movement acceleration of the digital camera 1 is reduced to zero. At the moment when the digital camera 1 collides against the ground and the like, movement acceleration of the digital camera 1 significantly increases and after the collision, movement acceleration of the digital camera 1 is reduced to acceleration of gravity. The digital camera 1 according to the embodiment has a reference acceleration predetermined assuming falling of the digital camera 1, and movement acceleration detected by the acceleration sensor 180 is compared with the reference acceleration.

In the case that movement acceleration of the digital camera 1 is the reference acceleration and over (step S4 in FIG. 8: Yes), the main CPU 110 judges that the digital camera 1 is not falling. This judgment is repeated until movement of the lens barrel 10 is completed or the main CPU 110 judges that the digital camera 1 is falling.

When movement of the lens barrel 10 is completed (step S5 in FIG. 8: Yes), the optical control CPU 120 gives the voltage application section 80a an instruction to release a voltage.

When the voltage application section 80a stops applying a voltage (step S6 in FIG. 8), as shown in FIG. 7A, the attractive electrostatic force between the upper electrode 81 with plus charge and the lower electrode 82 with minus charge is released, and the space member 80 expands between the electrode 81, 82. As a result, the space W between the rotational tube 53 and the translatory tube 56 of the lens barrel 10 is closed as shown in FIG. 9B.

After the space W is closed by the space member 80, an image is taken according to the press of the shutter button 32 by a user (step S7 in FIG. 8). If an image of a subject is taken in the state shown in FIG. 9A by using a conventional camera, an image shot by the digital camera 1 may deteriorate due to mixing of light incident from the subject with undesired light which invades through the space W. In the embodiment, it is possible to obtain an image with high quality by securely blocking off the harmful light before taking an image.

When an instruction of completion of shooting is given by a user (step S8 in FIG. 8: Yes), the main CPU 110 gives the optical control CPU 120 an instruction for collapse of the lens barrel 10.

Receiving the instruction for collapse of the lens barrel 10, the optical control CPU 120 gives the voltage application section 80a an instruction to apply a voltage and the voltage application section 80a applies a voltage to the space member 80 (step S9 in FIG. 8). As a result, as shown in FIG. 9A, the space W between the rotational tube 53 and the translatory tube 56 of the lens barrel 10 is opened.

When the space W is opened by the space member 80, the optical control CPU 120 causes the motor (not shown) and the like to drive the lens barrel 10 so as to be collapsed (step S10 in FIG. 8).

When the lens barrel 10 starts to be collapsed, in the same way as step S4 in FIG. 8, the main CPU 110 judges whether the digital camera 1 is falling or not, based on the detection result of the acceleration sensor 180. In the case that movement acceleration of the digital camera 1 is the reference acceleration and over (step S11 in FIG. 8: Yes), the main CPU 110 judges that the digital camera 1 is not falling. This judgment is also repeated until collapse of the lens barrel 10 is completed or the main CPU 110 judges that the digital camera 1 is falling.

When collapse of the lens barrel 10 is completed (step S12 in FIG. 8: Yes), the voltage application is stopped by an instruction of the optical control CPU 120 (step S13 in FIG. 8) and the space W in the lens barrel 10 is closed. When the power switch (not shown) is turned off, the power supply is stopped (step S14 in FIG. 8).

In the case that movement acceleration detected by the acceleration sensor 180 is lower than the reference acceleration in step S4: No in FIG. 8 or step S11 in FIG. 8, the main CPU 110 judges that the digital camera 1 is falling and gives the optical control CPU 120 an instruction so as to stop movement of the lens barrel 10.

Receiving the instruction for stop of movement of the lens barrel 10 from the main CPU 110, the optical control CPU 120 causes the motor (not shown) and the like to stop driving the lens barrel 10 so as to stop movement of the lens barrel 10 (step S15 in FIG. 8). Moreover the optical control CPU 120 gives a voltage application section 80a an instruction to release a voltage.

When the voltage application section 80a stops applying a voltage (step S16 in FIG. 8), the space W between the rotational tube 53 and the translatory tube 56 of the lens barrel 10 is closed as shown in FIG. 9B. A shaky potion of the lens barrel 10 and the like may be broken if the digital camera 1 falls in the extended state of the lens barrel 10. However, it is possible for the digital camera 1 to decrease damage of the lens barrel 10 in collision by closing the space W between the rotational tube 53 and the translatory tube 56, thereby enhancing the strength of the optical barrel.

Then, in the case that movement acceleration detected by the acceleration sensor 180 is the reference acceleration and over (step S17 in FIG. 8: Yes), the main CPU 110 judges that the digital camera 1 is static after collision against the ground and the like and gives the optical control CPU 120 an instruction so as to collapse the lens barrel 10. Then the process of step 9 and the steps following step 9 is carried out and the power switch (not shown) is turned off after collapse of the lens barrel 10.

As described above, according to the digital camera 1, opening the space W by the space member 80 makes it possible to drive the lens barrel 10 with less electric power consumption while the lens barrel 10 is moved. In addition, closing the space W by the space member 80 makes it possible to securely avoid the invasion of dust and undesired light while the lens barrel 10 is not moved.

The explanation of the first embodiment of the present invention is completed in the above. Next, the second embodiment of the present invention will be described below. The second embodiment is different from the first embodiment in the point of the shape of cross section of the space member, but the second embodiment has the common feature as that of the first embodiment except this point. Thus, the description below will focus on the different point without repeating the same explanation which has already made in the first embodiment. In the following description, the same components as those in the first embodiment will be denoted by the same reference numerals as the corresponding reference numerals in the first embodiment.

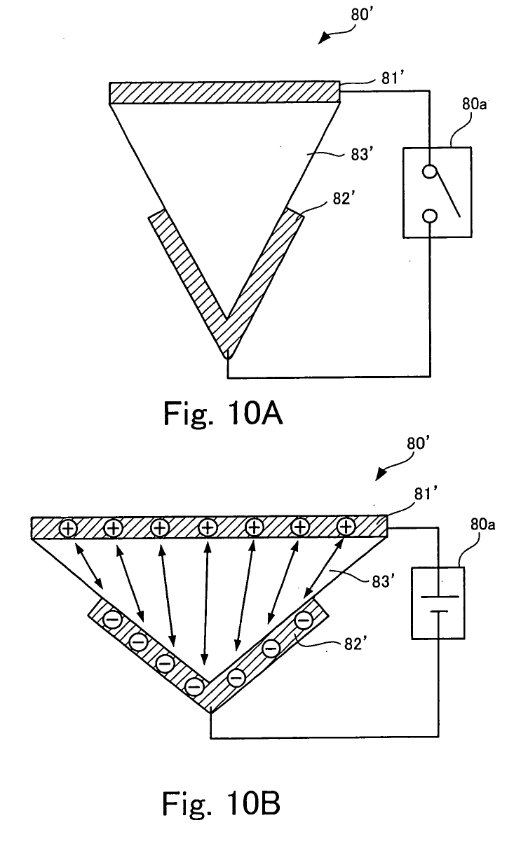

FIG. 10A and FIG. 10B show a sectional view of the space member 80′ which is employed in the second embodiment.

The space member 80′ is made of an O-ring 83′ whose cross section is triangular and two electrodes 81′, 82′ which sandwich the O-ring 83′.

When a voltage is applied to the space member 80 by the voltage application section 80a, due to the attractive electrostatic force between the electrode 81′ with plus charge and the electrode 82′ with minus charge, the O-ring 83′ is pushed from the both side and contracts in the direction along the width of the O-ring 83′ as shown in FIG. 10B.

Also in this embodiment, when the voltage application section 80a stops applying a voltage to the space member 80′, the electrostatic force between the electrode 81′, 82′ vanishes and the space member 80′ expands as shown in FIG. 10A.

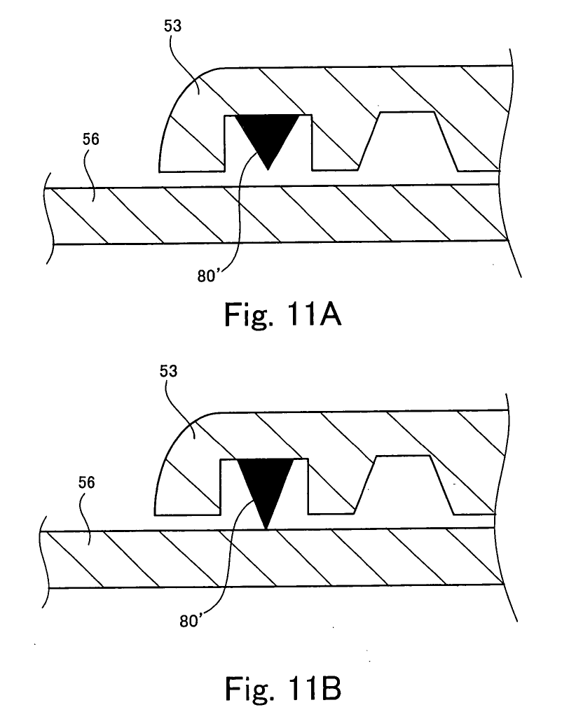

FIG. 11A and FIG. 11B show the relationship between the space member 80′ and the lens barrel 10.

As shown in FIG. 11A, the space member 80′ is glued on the rotational tube 53 with one of the three sides of the triangle of the cross section of the space member 80′. Also, when a voltage is applied to the space member 80′ by the voltage application section 80a, one of the three corners of the triangle formed by the space member contacts the translatory tube 56 as shown in FIG. 11B. It is possible to reduce a burden for driving the lens barrel 10 even if the lens barrel 10 is moved in the state that the space member 80′ contacts the translatory tube 56 because the contact area of the space member 80′ is small. As a result, it is possible to eliminate unnecessary electric power consumption in the digital camera in the second embodiment.

The explanation of the second embodiment of the present invention is completed in the above.

Next, examples of the components to be applied in the present invention will be described below.

In the above embodiments, a polymer actuator is employed as an example of the space member according to the present invention. The polymer actuator has electrodes and a property to block off light. Polymers available for use in polymer actuators include polymer gels, ion conducting polymers, electron conducting polymers, electrostrictive polymers (dielectric elastomers and electrostatic elastomers), piezoelectric polymers, and liquid crystal elastomers. Above all, electrostrictive polymers are preferable. Polymer actuators are described in: “Forefront in the Development of Soft Actuators—toward Realization of Artificial Muscles,” Yoshihito Osada, et al., NTS, 2004; “Electroactive Polymer (EAP) Actuators as Artificial Muscles—Reality, Potential and Challenges,” Editor: Yoseph Bar-Cohen SPIE PRESS Vol. 2001; and “Electroactive Polymer (EAP) Actuators as Artificial Muscles: Reality, Potential, and Challenges, Second Edition,” Editor(s): Yoseph Bar-Cohen, posted in 2004.

Regarding how to give a polymer actuator a property of blocking light, it can be achieved by disposing light blocking material on the surface of a polymer actuator or inside a polymer actuator. Also, it is acceptable (preferable) to use the electrodes as the light blocking material. It is possible to employ the known light blocking material as the light blocking material, for example, a black blend or a black dye and the like made of combination of carbon-black or black pigments and a plurality of kinds of colored pigments.

<Properties of Various Polymer Actuators and Literature and Patent thereof >

1. Polymer Gels

Regarding polymer electrolyte gels which have electric charge on their polymer network, there are the known actuators which makes use of the property of polymer electrolyte gels, that is, the feature of expanding and contracting by absorbing and releasing of solvents such as water according to changes of an electric field. For example, Japanese Patent Laid-Open No. H5-44706 discloses a polymer electrolyte gel which shows deformation in the direction different from that of an applied electric field, by instantly contracting in the direction of the applied electric field and expanding in the direction orthogonal to the applied electric field. Japanese Patent Laid-Open No. H5-87042 discloses a micro-pump in which a polymer electrolyte gel is used and Japanese Utility Model Laid-Open No. H5-57551 discloses a linear actuator in which a polymer electrolyte gel is used.

2. Ion Conducting Polymers (ICPF)

Ion conducting polymer actuators are actuators which have membranes of ion exchanging resin such as perfluoro-sulfonic acid, perfluoro-calbonic acid and so on, and plated electrodes on the surfaces of the membranes. These actuators make use of the fact for the generation of driving force that ions movable in the resin which can move when an electric field is applied are attracted together with water molecules toward one of the electrodes and this electrode bends by expanding. Japanese Patent Laid-Open No. H4-275078 discloses an example of an ion conducting polymer actuator which is appropriate for realizing a compact-sized actuator and quickly reacts with less electric power. Also, Japanese Patent Laid-Open No. H8-10336 and Japanese Patent Laid-Open No. H11-198069 discloses a medical tube which has an ion conducting polymer actuator on its tip with more than two electrodes formed in the position where a membrane of ion exchanging resin is sandwiched and a micro-device for medical purposes or for mechanical piping. The medical tube exhibits good efficiency about performance for operations and the like because the ion conducting polymer actuator on its tip quickly reacts with a low voltage. Moreover, Japanese Patent Laid-Open No. 2004-28994 discloses an ion conducting polymer actuator and a ion exchanging product made by combining some ion exchanging materials which is appropriate for the ion conducting polymer actuator.

3. Electron Conducting Polymers

Conducting polymers such as poly-pyrrole has a property of expanding and contracting (electrolyte expansion and contraction) by doping and inverse doping. Recently there is found materials which expand and contract with an extremely high rate of expansion and contraction and generate large power with a low voltage. For example, Japanese Patent Laid-Open No. H11-169393 and Japanese Patent Laid-Open No. H11-169394 disclose possibility to use artificial muscles in which an aniline membrane is formed in the both sides of a solid electrolyte forming material. Also, “Synthetic Metals (vol.90 pp.93, 1997)” reports a structure of an actuator which has an electrolyte liquid, a pair of electrodes, and a poly-pyrrole film. Moreover, Japanese Patent Laid-Open No. 2005-110494 discloses a conducting polymer complex bundle which is formed by accumulating layers of conducting polymer complexes which have conducting polymer layers on spiral conducting bodies.

4. Electrostrictive Polymer

Regarding electrostrictive polymers (dielectric elastomers), electrostrictive polymer actuators are known which have electrodes attached to both sides of a polymer (elastomer) that exhibits rubber-like viscoelastic behavior. For example, National Publication of International Patent Application No. 2003-506858 discloses an electrostrictive polymer actuator which has electrodes equipped with conformable contacts and capable of deforming under strain and which utilizes the characteristics of a polymer membrane to contract along an electric field and expand in a direction orthogonal to the electric field as a result of electrostatic attraction between the electrodes when a high voltage is applied between the electrodes. Possible applications of this actuator include diaphragms or linear actuators. Besides, National Publication of International Patent Application No. 2003-526213 discloses a heel-grounded generator incorporated in heels of footwear and used to convert mechanical energy generated during bipedal locomotion of man into electrical energy. Typical electrostrictive polymers significantly expand and contract, and thus have rapid responsibility and are suitable for use in dry atmosphere.

5. Piezoelectric Polymers (Piezo Polymers)

Regarding piezoelectric polymers, it is well-known that piezo mainly made of piezoelectric ceramics is commonly used as an actuator of an ink jet printer. But, piezoelectric polymers having piezoelectricity such as PVDF and so on is also under consideration as a possible actuator. Piezoelectric polymers has a property of quick reaction and is available in dry circumstances, but has some problem related with low rate of expansion and contraction and generation of low power. For example, Japanese Patent Application Laid-Open No. H3-343397 (Olympus) discloses a holding equipment which has a narrow insertion section, a piezoelectric polymer actuator formed on the tip of the insertion section and a lead wire which transmits driving signals to the piezoelectric polymer actuator. In this holding equipment, it is possible to drive the piezoelectric polymer actuator with quick reaction when supplied with a driving signal through the lead wire. In this holding equipment, it is also possible to secure safety because there is no necessity to increase temperature, unlike form remembering alloy. Moreover, National Publication of International Patent Application No. 8-508111 discloses an active noise and vibration eliminating foaming plastic and so on which contains some layers made of embedding formatted curved PolyVinylide DiFluoride (PVDF) piezoelectric material.

6. Liquid Crystal Elastomers

Regarding liquid crystal elastomers, “Nature magazine (410, 447 (2001))” reports an attempt to convert electrical energy into mechanical energy using orientation changes of mesogens due to an electric field generated by a ferroelectric liquid crystal elastomer. This attempt attracts attention as a new application of liquid crystals. In this example, an applied voltage of 1.5 MVm⁻¹ achieves a displacement of 4%. Also, Japanese Patent Laid-Open No. 2003-205496 discloses a liquid crystal actuator which uses a liquid crystal elastomer stretched along its length. Furthermore, “Macromolecules (34, 5868 (2001))” reports that changes in the shape (volume) of liquid crystals due to thermally induced phase transition of the liquid crystals are to be made use of for an actuator.

In the above description, the embodiments of the optical barrel according to the present invention are examples applied to a digital camera, but the optical barrel according, to the present invention may be, for example, a portable phone and a film camera in which a subject image is made on a film.

Incidentally, the above embodiment employs, as an example, the space member whose cross section is elliptical or triangular and which is formed as a ring. However, the present invention is not limited to these and the embodiments described above may employ the space member whose cross section is in another shape other than a triangle, for example, sheer circular or polygonal. Also, the present invention may employ the space member which is not formed as a ring and is mounted only in the portion where blocking of light is desired.

What is claimed is:

1. An optical barrel accommodating an optical system, the optical barrel comprising:
an outer wall having a plurality of tube members which are each in tube form and are engaged one another in such a manner that one tube is inserted inside another and are relatively moved by a driving force; and
space members mounted between the plurality of tube members which open and close the spaces between the plurality of tube members by expanding and contracting in response to application and release of a voltage.

2. The optical barrel according to claim 1, wherein the space members each include opaque members and block off light incident through the spaces between the plurality of tube members, by expanding in response to either of application and release of a voltage.

3. The optical barrel according to claim 1, wherein the space members include polymer actuators.

4. The optical barrel according to claim 1, wherein the space members are rings whose cross sections are circular.

5. The optical barrel according to claim 1, wherein the space members are rings whose cross sections are in polygonal form, corners of which contact and separate from the tube members, by expanding and contracting in response to application and release of a voltage.

6. An optical controller comprising:
(a) an optical barrel having;
(i) an outer wall having a plurality of tube members which are each in tube form and are engaged one another in such a manner that one tube is inserted inside another and are relatively moved by a driving force: and
(ii) space members mounted between the plurality of tube members which open and close the spaces between the plurality of tube members by expanding and contracting in response to application and release of a voltage,
(b) an optical system which is accommodated in the optical barrel, which subject light passes through and whose optical ability is changed according to the relative movement of the plurality of tube members of the optical barrel; and
(c) a control section which controls closing and opening of the spaces by controlling application and release of a voltage with respect to the space member.

7. An image taking apparatus comprising:
(a) an optical barrel having;
(i) an outer wall having a plurality of tube members which are each in tube form and are engaged one another in such a manner that one tube is inserted inside another and are relatively moved by a driving force: and
(ii) space members mounted between the plurality of tube members which open and close the spaces between the plurality of tube members by expanding and contracting in response to application and release of a voltage,
(b) an optical system which is accommodated in the optical barrel, which subject light passes through and whose optical ability is changed according to the relative movement of the plurality of tube members of the optical barrel;
(c) a control section which controls closing and opening of the spaces by controlling application and release of a voltage with respect to the space member; and
(d) an imaging section which shoots an image formed by the subject light.

8. The image taking apparatus according to claim 7, further comprising a tube member driving section which gives the plurality of tube members a driving force, thereby moving the plurality of tube members relatively, wherein the control section causes the respective space members to close or open the spaces, depending upon whether the tube members are being moved by the tube member driving section.

9. The image taking apparatus according to claim 7, further comprising:
an acceleration detection section which detects acceleration of movement of the image taking apparatus; and
a tube member driving section which gives the plurality of tube members a driving force thereby moving the plurality of tube members relatively and stops the movement of the plurality of tube members in the case that acceleration detected by the acceleration detection section is over a predetermined acceleration,
wherein the control section causes the space members to close the spaces in the case that acceleration detected by the acceleration detection section is over the predetermined acceleration.
